(19) United States
(12) Patent Application Publication
(10) Pub. No.: US 2009/0035732 A1
(43) Pub. Date: Feb. 5, 2009

(54) METHOD FOR LEARNING, TEACHING AND TRAINING DATACENTER IT SOLUTIONS, A DATACENTER IT SOLUTION KIT, AND A METHOD FOR TROUBLESHOOTING A DATACENTER

(76) Inventors: Thanaraj Kanagalingam, Singapore (SG); Gowthaman Manickam, Singapore (SG)

Correspondence Address: EAGLE IP LIMITED, 22/F., KWAI HUNG HOLDINGS CENTRE, 89 KING'S ROAD, NORTH POINT, HK

(21) Appl. No.: 11/829,979

(22) Filed: Jul. 30, 2007

(51) Int. Cl. G09B 19/00

(52) U.S. Cl. 434/118

(57) ABSTRACT

A set of pre-defined datacenter IT solution tasks which are to be performed by a user for setting up or for extending a datacenter is provided for a pre-defined IT solution. Groups of basic tasks and learning tasks are provided such that each learning task comprises one or more basic task. A sequence of interface tasks is assigned to the basic tasks and learning tasks. An interface task provides a predefined instruction or set of instructions for validation or for verification of the correctness of the performed learning task or interface task. This is done by evaluating a characteristic behaviour of the datacenter and not necessarily by monitoring each step of the user who is fulfilling the tasks.

### TECHNOLOGY FIELD

The application relates to the IT Information Technology field relevant to the design, implementation and troubleshooting for datacenter IT solutions and to methods for learning, teaching and training datacenter IT solutions, operations and management.

### SUMMARY

The application provides a set of pre-defined datacenter IT solution asks which are to be performed by at least one user for setting up or for extending a datacenter for providing a pre-defined IT solution. The datacenter IT solution tasks are provided in groups of basic tasks and groups of learning tasks, such that each learning task comprises one or more basic task. According to a further step, there is provided a sequence of interface tasks, wherein at least one interface task being assigned to a least one basic task or to at least one learning task. An interface task provides a predefined instruction or set of instructions for validation or for verification of the correctness of the performed learning task or interface task. This is done by evaluating a characteristic behaviour of the datacenter and not necessarily by monitoring each step of the user who is fulfilling the tasks.

The reverse sequence of the interface tasks provides a set of instructions for identifying the root cause of a technical problem in the datacenter IT solution.

A data center is a facility used to house mission critical computer systems and associated components. It generally includes environmental controls such as air conditioning, fire suppression, etc., redundant/backup power supplies, redundant data communications connections and high security, highlighted by biometric access controls throughout the entire buildings.

A datacenter IT solution is in general not the facility or the building but computer hardware, software and communications equipments such as date network facilities.

The application also provides a set of pre-defined datacenter set-up tasks according, wherein a corresponding interface task is provided for each basic task or for each leaning task.

For providing these groups of learning tasks, groups of basic tasks and a sequence of interface tasks, the sequence of the respective interface tasks is maintained. This can be used for teaching the information to an individual or to a group of individuals, by transmitting the information to the individual or to the group of individuals, by providing it orally by an individual such as a teacher, in a written form on paper, or by data which is downloaded from a network such as the Internet or from a data carrier.

A training of at Least one individual or a group of individuals, comprises the teaching of the information until a pre-determined current learning task or basic task is reached, causing the individual to repeat the basic tasks and learning tasks that have been taught so far, performing the current interface task which is assigned to the current basic task or learning task, that has been taught, and verifying whether the datacenter IT solution comprises the characteristic behaviour of the current interface task. Thereby the result is compared with what is expected.

If the verification step was successful the training steps are performed until reaching the next pre-determined learning task or basic task, performing the interface task which is assigned to the next basic task or learning task, that has been taught, and verifying whether the datacenter IT solution comprises the characteristic behavior of that next interface task.

Otherwise, if the verification step was not successful, the training steps are repeated again until reaching the current learning task or basic task, performing again the current interface task, and verifying again whether the datacenter IT solution comprises the characteristic behavior of the current interface task.

Otherwise, if the verification step was not successful two or more times, the training steps are performed until reaching a previous pre-determined learning task or basic task, performing the previous interface task which is assigned to the previous basic task or learning task, and verifying whether the datacenter IT solution comprises the characteristic behavior of the previous interface task.

The training of at least one individual or a group of individuals can also comprise providing a problem in a datacenter IT solution. This will prepare the individuals for real-world situations. The individual is then caused to solve the problem by performing the reverse sequence of the interface tasks, for each interface task verifying whether the datacenter IT solution comprises the characteristic behavior of that Interface task. If a verification step is not successful for a current interface task then the basic and learning tasks which are assigned to the current interface task are performed. This is a safe and short way to solve a problem in a datacenter IT solution.

If a verification step is not successful for an interface task before the current interface task then the basic and learning tasks which are assigned to the interface task before the current interface task are performed. This approach makes sure that two or more problems on different levels can be solved.

The application provides also printed matter, a data carrier and a computer program with the information, whereby the computer acts as a teacher, as a trainer, as a trainee or as a user.

All individuals in the aforementioned contexts can also include an intelligent computer program or a machine such as a robot.

The datacenter IT Solution Kit of the application comprises a single portable rack which is housing IT equipments.

### BRIEF DESCRIPTION OF THE FIGURES

The embodiment can be better understood with reference to the following drawings and description. The components in the figures are not to scale, instead emphasis is placed on illustrating the principles of the application, while the reference numerals designate the corresponding parts. In the drawings:

FIG. 1 Schematic of the basic task

FIG. 2 Schematic of the interface task of basic task

FIG. 3 Schematic of the learning task

FIG. 4 Schematic of the interface task of learning task

FIG. 5 Schematic of the curriculum

FIG. 6 Schematic of managing a problem—troubleshooting

FIG. 7 Example of Datacenter IT Solution Kit

FIG. 8 Schematic of the curriculum: Storage Infrastructure

FIG. 9 Schematic of the learning task SAN cabling

FIG. 10 Example of Datacenter IT Solution Kit used in Curriculum Storage Infrastructure

FIG. 11 Schematic of troubleshooting using Curriculum Storage Infrastructure

FIG. 12 Schematic of troubleshooting using learning task SAN cabling

### DETAILED DESCRIPTION

Business or technical requirements drive datacenter IT solutions. IT solutions comprise of various technology products, people and processes. Different technology vendors specify how their IT products are used in order to meet parts of requirements of the IT solutions, operations and management. For example, if the business requirement is to reduce storage operation cost, an IT solution is an external storage consolidation. Technology vendors will propose an external storage with the capability to connect with heterogeneous servers. However, the complexity of the solution arises with heterogeneous connectivity, operations and management. In addition, the plurality of IT equipments in a datacenter often creates blame-storms by technology vendors whenever there is a problem.

A blame-storm is a situation where multiple technology vendors cannot conclude which IT equipment or vendor technology is at fault in causing the problem.

Currently there is no structured approach for designing, implementing and troubleshooting the heterogeneous datacenter IT solutions by IT practitioners. One purpose of the application is to provide a structured way of designing, implementing and troubleshooting datacenter IT solutions for IT practitioners and structured methods for learning, training and teaching datacenter IT solutions, operations and management for learning institutes using the Datacenter IT Solution Kit.

The application comprises a structured method for the designing, implementing and troubleshooting practical datacenter IT solutions. In addition, the structured method is intended for the learning, teaching and training of datacenter IT solutions, operations and management. The application comprises also a Datacenter IT Solution Kit that serves as part of the learning, teaching and training of datacenter IT solutions, operations and management.

The application can be illustrated as follows:
1. The method of teaching datacenter IT Solution in a portable kit form.
2. The portable kit form is a combination of multi-vendor industry standard IT equipments hardware and system related software assembled in a portable rack form.
3. The application is defined on vendor neutral, industry standards.
4. The method of learning, teaching and training illustrates the concepts of the technology and real world examples of the IT solutions implemented in the datacenters.
5. The curriculum content related to the method of learning, teaching and training is adaptable to future developed technologies. But the method and process of learning, teaching and training IT datacenter solutions in kit form will remain relevant at all times.
6. The application can be applied to any aspect of datacenter IT solutions, operations and management.

A first embodiment of the application is a structured method to design, implement and troubleshoot datacenter IT solutions. The application also serves as a structured method to learning, teaching and training datacenter IT solutions, operations and management.

The embodiment comprises of:
Methodology and/or process of designing, implementing and troubleshooting practical industry datacenter IT solutions.
Methodology and/or process of learning/teaching/training practical industry IT solutions, operations and management.
A vendor-neutral solution with a plurality of IT equipments.
Based on the Information Technology Industry Standard/International Standard.
Framework for Courseware which emphasizes the concepts of the technology and real-world datacenter IT solutions, operations and management.

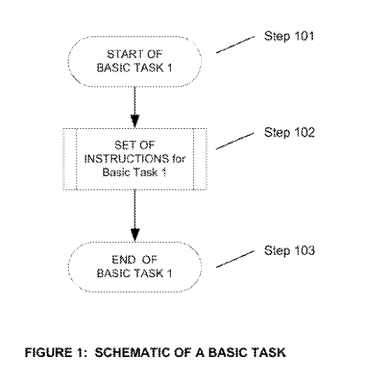

FIG. 1 to FIG. 6 show diagrams of the structured method of “learning” on a datacenter IT solution according to the application.

The following definitions are used in the description of the embodiments:
A curriculum is defined as a set of learning tasks.
A learning task is defined as a set of basic tasks.
A basic task is a predefined set of instructions to a user, such as a trainee.
An interface task is a predefined instruction or set of instructions to a user that links either two learning tasks or two basic tasks together in terms of sequence for validation/verification and also for troubleshooting problems.

The term “learning” includes the processes of teaching, training and assessing of a user, such as an individual candidate (‘trainee’) or a group of candidates (‘trainees’).

A basic task describes the handling of a simple form of datacenter IT activities that are demonstrated via the Datacenter IT Solution Kit. A basic task will have the following attributes:
It will typically comprise of the operations performed on the hardware or software provided by IT technology vendors by a user.
It is performed through a set of predefined instructions by a user.
These predefined instructions are commands supplied by the IT technology vendors.

FIG. 1 shows the schematic of a Basic Task 1, as follows:
Step 101: The start of a basic task 1 is performed.
Step 102: A predefined set of instructions for the basic task 1 is performed by a user.
Step 133: The basic task 1 ends.

A Basic Task 1 is completed when the related interface task of the Basic Task 1 is successfully performed, thereby confirming the correctness of the Basic Task 1.

An Interface task is a set of instructions that links either two learning tasks or basic tasks in terms of sequence, validation. Interface tasks are also used in troubleshooting of IT solutions.

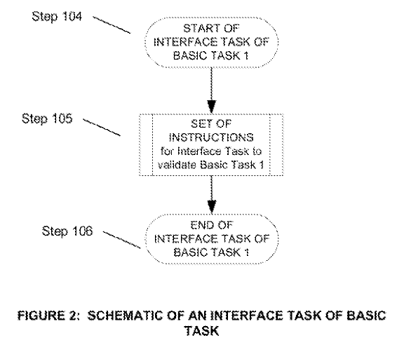

FIG. 2 shows the schematic of an interface task for Basic Task of FIG. 1 as follows:
Step 104: The start of an interface task of the Basic Task 1 is performed.
Step 105: A predefined set of instructions for the interface task of Basic Task 1 is performed by a user (‘trainee’ or ‘instructor’). The user validates whether the Basic Task 1 is performed successfully.
Step 106: The interface task of Basic Task 1 ends.

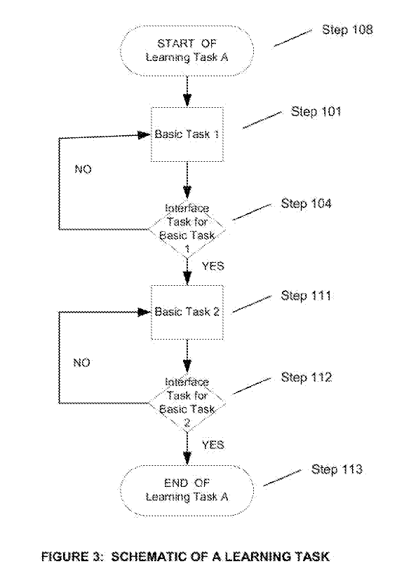

FIG. 3 shows the schematic of a learning task A which is built from various basic tasks and interface tasks. A learning task describes the handling of datacenter IT scenarios that are found in datacenter IT solutions, operations and management. A learning task is performed through a predefined set of basic tasks and interface tasks. The Learning Task A is built from two basic tasks—Basic Task 1 and Basic Task 2. Each basic task has a predefined interface task.
Step 108: The start of a Learning Task A is performed.
Step 101: Basic Task 1 is performed by user (‘trainee’) as shown in FIG. 1.
Step 104: Interface task for Basic Task 1 is performed by user as shown in FIG. 2. If the validation of Basic Task 1 is successful (‘yes’), then the user continues to the next basic task. If the validation is not successful (‘no’), the user repeats the Basic Task 1.
Step 111: Basic Task 2 is performed by user.
Step 112: Interface task for Basic Task 2 is performed by user as shown in FIG. 2. If the validation of Basic Task 1 is successful (‘yes’), the user continues to the next basic task. If the validation is not successful (‘no’), the user repeats the Basic Task 1.
Step 113: The Learning Task A ends.

A Learning Task A is completed when the related interface task of the Learning Task A is successfully performed, thereby confirming the correctness of the Learning Task A.

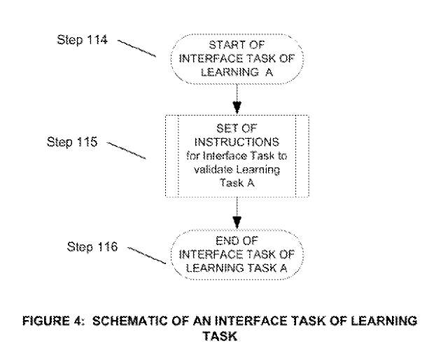

FIG. 4 shows the schematic of an interface task of Learning Task A as follows:
Step 114: The start of an interface task of Learning Task A is performed.
Step 115: A predefined set of instructions for the interface task of learning task is performed by a user (‘trainee’ or ‘instructor’). The user validates whether the Learning Task A is performed successfully.
Step 116: The interface task of Learning Task A ends.

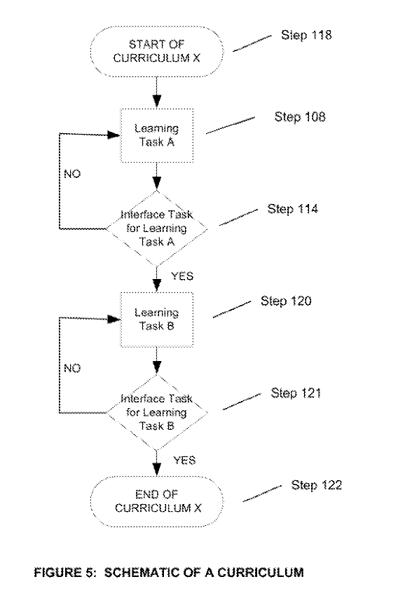

FIG. 5 shows the process of a curriculum built from learning tasks. A curriculum is a datacenter IT solution, operations or management built from learning tasks. The Curriculum X is built from two learning tasks—Learning Task 1 and Learning Task 2. Each learning task has its own interface task.
Step 116: The start of Curriculum X is performed.
Step 108: Learning Task A is performed by user as shown in FIG. 3.
Step 114: Interface task for Learning Task A is performed by user as shown in FIG. 4. If the validation of Learning Task A is successful (‘yes’), the user continues to the next learning task. If the validation is not successful (‘no’), the user repeats the Learning Task A.
Step 120: Learning Task B is performed by user.
Step 121: Interface task for Learning Task B is performed by user. If the validation of Learning Task B is successful (‘yes’), the user continues to the next learning task. If the validation is not successful (‘no’), the user repeats the Learning Task B.
Step 122: The Curriculum X ends.

The following is a simple algorithm for performing basic tasks and its related interface task within a learning task:

Definition:
n is the total number of basic task in learning task

Process:
Execute the Basic Task x, x is from 1 to n.
Execute the interface task of Basic Task x.
If Interface Task x is not successful, then perform Basic Task x again.
If Interface Task x is successful, then perform next basic task.
Continue until interface task n is successful.

The following is a simple algorithm for performing learning tasks and its related interface task within a curriculum:

Definition:
m is the total number of learning tasks in the curriculum.

Process:
Execute the Learning Task y, y is from 1 to m.
Execute the interface task of Learning Task y.
If Interface Task y is not successful, then perform Basic Task y again.
If Interface Task y is successful, then perform next basic task.
Continue until Interface Task m is successful.

All basic tasks/learning tasks are sequentially arranged according to a predefined order. Interface task is the validation or checkpoint to show the status of completion of one basic task (or learning task) and before proceeding to another basic task (or learning task).

The reverse sequence of the defined structured approach of the method of learning, teaching and training helps to provide troubleshooting the problem and resolution of datacenter IT solution. By performing the interface tasks of learning task or basic task, we are able to identify the root cause of a technical problem. In order to resolve the technical problem, we perform the learning tasks or basic tasks ahead of the interface task. The Datacenter IT Solution Kit is used to provide error messages that are part of the method of earning, teaching, training datacenter IT solutions, operations and management.

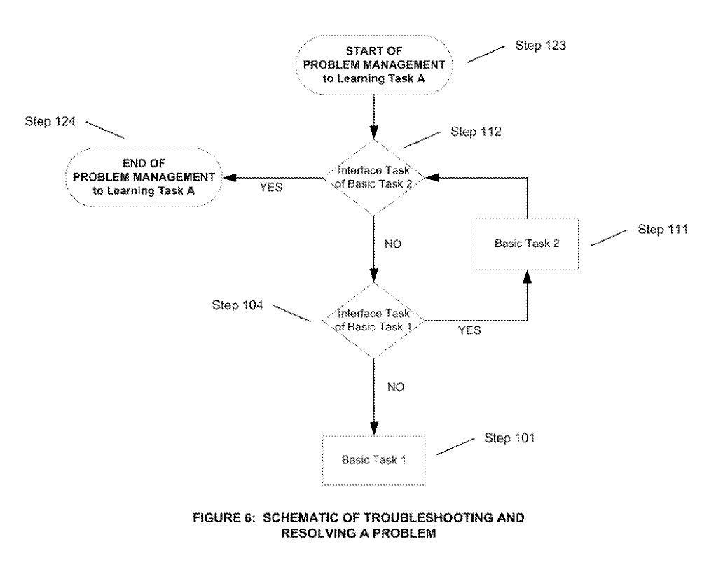

FIG. 6 shows a schematic of troubleshooting a problem for a learning task.
Step 123: The start of problem management to Learning Task A is performed.
Step 112: Interface task for Basic Task 2 is performed by a user. If interface task is not performed successfully (‘NO’), then go to step 104. If interface task is performed successfully (‘YES’), then go to step 124.
Step 111: Basic Task 2 is performed by a user.
Step 104: Interface task for Basic Task 1 is performed by a user. If interface task is not performed successfully (‘NO’), then go to step 101. If interface task is performed successfully (‘YES’), go to step 111.
Step 101: Basic Task 1 is performed by a user.
Step 124: The problem management of Learning Task A ends.

As for troubleshooting and resolution, the method of learning, teaching and training for a learning task can be as follows:

Definition:
n is the total number of basic task in learning task

Process:
Execute the Interface Task n.
If Interface Task n fails, then continue to the next Interface Task n-1.
Continue until Interface Task x is successful where 1=<x<=n.
Execute Basic Task x+1 and Interface Task x+1.
Continue until Basic Task n and Interface Task n.

As for troubleshooting and resolution, the method of learning, teaching and training for a curriculum can be as follows:

Definition:
m is the total number of learning task in curriculum

Process:
Execute the Interface Task m.
If Interface Task n fails, then continue to the next Interface Task m-1.
Continue until Interface Task x is successful, where 1=<x<=m.
Execute Learning Task x+1 and Interface Task x+1.
Continue till Learning Task m and Interface Task m.

The application provides a specific way of arranging the multitude of possible basic tasks which apply to the different parts of an IT solution. The outcome of the arrangement provides both a method for teaching, learning and training as well in a reverse order, so that it could also be a method for troubleshooting a problem in the IT solution. Not all and every arrangement of basic tasks will provide these two functions at the same time.

A person skilled in the art will, after carefully studying the approach of the application, know how to generate an appropriate curriculum starting from the basic task in the form of a given set of instructions for the different components which make an IT solution.

The application comprises also a Datacenter IT Solution Kit which is housed in a portable equipment rack. It comes with preassembled real-world datacenter IT equipments from different vendors together with training material for designing the IT solution to meet business or technical requirements, for implementing and troubleshooting the solution and thereby learning, managing and operating the solution.

Thereby, the Datacenter IT Solution Kit of the application serves as a practical aid in teaching, learning and training datacenter IT solutions, operations and management.

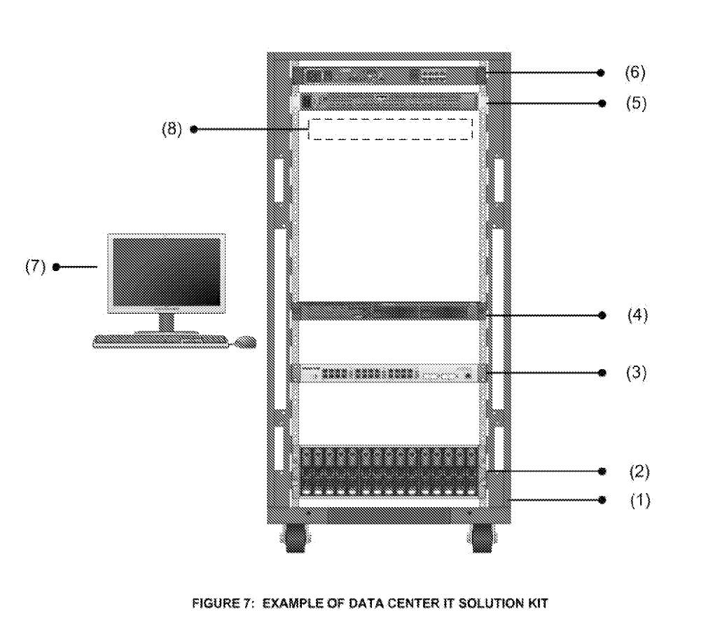

FIG. 7 shows an example of The Datacenter IT Solution Kit which comprises of a datacenter IT equipments from IT technology vendors used for building blocks for the Datacentre IT Solution Kit. It is housed in a single portable rack (1), which contains at least one of each of the following:
external storage device (2)
SAN switch device (3)
server (4)
Ethernet network device e.g. a LAN switch (5)
console device (6)
keyboard/mouse device and a monitor display that can be housed within the rack or externally (7)
patch panel for interconnecting the various IT equipments by the user to meet the curriculum requirements, and which is placed at the rear of the rack (8)
application software which is running on the server
system management software which runs on the server
connection for supplying electrical power to the components in the rack
connection with a super-ordinate data network for remote administration.

These components are provided such that they interact as a computer network that is operable. One would, under circumstances of the normal use of these components, not provide the above-mentioned components in a portable rack or housing. These components are built to be provided at positions that are distant from each other. These equipments are connected through the FC/UTP patch panel based on the curriculum requirements.

‘Portable’ refers that the rack can be easily transferred from one location to another as for example, by rollers which are mounted under the rack without unplugging more than a power cord and a connection to super-ordinate data network such as the Internet or VPN

In an advantageous embodiment, the datacenter IT equipment connections are provided in a patch panel. The connections between the datacenter IT equipments are not connected directly but over the patch panel, this helps to improve the structured approach of the application.

The Datacenter IT Solution Kit is the ‘apparatus’ used in the ‘IT Solution Curriculum’.

The method of the embodiment can be delivered in a comprehensive booklet with assignments that includes:
A design of IT solution to meet the specific business or technical requirements.
A brief explanation of all the tasks involved for this curriculum of learning task, basic task and interface task.
Learning task, basic task and interface task descriptions.
Thinking processes emphasized through the reverse sequence of the method of learning, teaching and training as they are used for troubleshooting.

Both the method and the device of the embodiment are used by an individual (“trainee”) or by a group (“trainees”) for building an IT solution for datacenter. The trainee will be trained based on learning tasks, basic tasks and interface tasks. Using the Datacenter IT Solution Kit, the trainee learns practical aspects of the datacenter IT solution, operation and management. With this knowledge, the trainee develops professional skills in building real-world datacenter IT solutions, and in identifying and resolving problems (troubleshooting) during the operations and management of datacenter IT solutions.

A supervisor is provided in the learning, teaching and training datacenter IT solutions, operations and management. The supervisor supports the trainee to perceive the information which is provided for the learning tasks, and basics tasks, for enabling the trainee in doing the executions which are provided for the learning tasks and basic tasks, and for verifying that the trainee successfully does the executions of the relevant interface tasks. The role of the supervisor is among others, to select and filter information for the trainee's consideration, to provide thought-provoking questions and to facilitate well-considered discussions.

The supervisor can be provided remotely via a telecommunication device or by a program running on the server and using I/O capabilities (video, audio, network interfaces) of the Datacenter IT Solution Kit.

### EXAMPLE 1 OF THE APPLICATION: CURRICULUM

The example covers the following steps:
1. Defining the business or technical requirement.
2. Providing the datacenter IT solution for fulfilling the business requirement by providing a predefined set of IT equipments.
3. Defining a curriculum which provides both as a means for teaching a user on how to design and implement the datacenter IT solution and on how to troubleshoot if a problem arises.

Terminology

Datacenter: is a facility used to house mission critical computer systems and associated components. It generally includes environmental controls (air conditioning, fire suppression, etc.), redundant/backup power supplies, redundant data communications connections and high security. Storage Area Network (SAN): is a network whose primary purpose is the transfer of data between computer systems and storage elements and among storage elements, which consists of a communication infrastructure providing physical connections, and a management layer, which organizes the connections, storage elements, and computer systems so that data transfer is secure and robust.

Host Bus Adapter (HBA): In computer hardware, a host controller, host adapter, or host bus adapter (HBA) connects a host system (the computer) to other network and storage devices.

Fiber Channel (FC): is a gigabit-speed network technology primarily used for storage networking. Fiber Channel is standardized in the T11 Technical Committee of the International Committee for Information Technology Standards (INCITS), an American National Standards Institute (ANSI)-accredited standards committee.

Fiber Channel Protocol (FCP) is the interface protocol of SCSI on the fiber channel.

Server: is an intelligent device, usually a computer, that provides services to other intelligent devices, usually other computers or appliances.

Business requirement: is a shared storage Solution, which means applications should be able to access data from an external centralized storage.

Datacenter IT solution: is the end-to-end solution which requires the understanding of all layers of the IT equipments (including the technology and technology standards), starting from:
SAN designs and configurations,
Storage arrays solutions, operations and management,
SAN fabric solutions, operation and management,
Host bus adaptor solutions, operation, management,
Server solutions, operations and management,
Application software solutions, operations and management.

The complexity of the solution arises due to the number of technology vendors that can be engaged in the solution as follows:
SAN fabrics vendor—This technology vendor provides the connecting piece from the servers to storage arrays (where the data is stored).
Server vendor—This technology vendor provide the system to house the HBA (host bus adaptor), operating system, middleware and the applications (the business logic). These applications access the data from the storage array through the HBA.
Host bus adaptors vendor—This technology vendor provides the interconnecting device to translate application requests for data in the form accepted by storage arrays.
Storage arrays vendor—This technology vendor provides the external storage to store the data required by the application.
Applications vendor—This technology vendor which provides the application logic.
SAN management vendor—this technology vendor provide the software to manage the SAN fabrics, HBA adaptors and storage arrays up to the server.

Each vendor focuses on their products' perspective to meet the point requirements and not the end-to-end solution to meet the business or technical requirements.

The embodiment is a structured method for design, implementation and troubleshooting datacenter IT solution and structured method for learning, teaching, training the different layers of technology concepts, technology standards, related IT equipments integration to form the datacenter IT solutions, operations and management in a sequential way, so that the practitioner or the candidate builds the technology fundamentals as well as the IT solution design.

A shared storage requirement is translated to our curriculum ‘Storage Infrastructure’ which covers:
SAN Definition
In computing, a storage area network (SAN) is an architecture to attach remote computer storage devices such as disk array controllers, tape libraries and CD arrays to servers in such a way that to the operating system the devices appear as locally attached devices. This teaches or trains the user on the basic technology fundamental concepts from the standards forum.
SAN Communication Protocols
Most storage networks use the SCSI protocol for communication between servers and disk drive devices. By contrast to a SAN, network attached storage (NAS) uses file-based protocols such as NFS or SMB/CIFS.
The transport protocol is fiber channel protocol as standards. This teaches or trains the user on the details of the different protocols standards used in the different IT equipment in this solution.
SAN Switches
This is one of the IT equipment, which provides the connectivity between the different servers to the different or single storage arrays.
This teaches or trains the user on how the different technologies are used in this equipment and how to operate and manage this equipment.
Storage Arrays
This is one of the IT equipment, which stores the actual data from a single or various servers. This teaches or trains the user on how the different technologies are used in this equipment and how to operate and manage this equipment.
Server
These servers are IT equipments, which host the application, and it is connected to the storage arrays for storing or retrieving data. These hosts can be connected directly to Storage arrays or through switches. This teaches or trains the user on how the data is retrieved or stored from an external storage by the server.
Application Software
This addresses the ability of the application softwares to access data from the shared storage solution. This teaches or trains the user on the next layer after which is the business application logic layer which is accessing the data.

In the above example, it is demonstrated how the embodiment copes with the fact that real-world datacenters IT solutions are not built on a single vendor hardware and software list of products or single technology. It is most often built on multi-vendor hardware and software or multiple technologies so that it provides complete end-to-end solution to meet the business or technical requirements.

Let Curriculum X=Storage Infrastructure
Learning Task A=SAN cabling
Learning Task B=HBA installation and configuration
Learning Task C FCP and protocol tracing
Learning Task D=switch configuration
Learning Task E=implementing SAN security

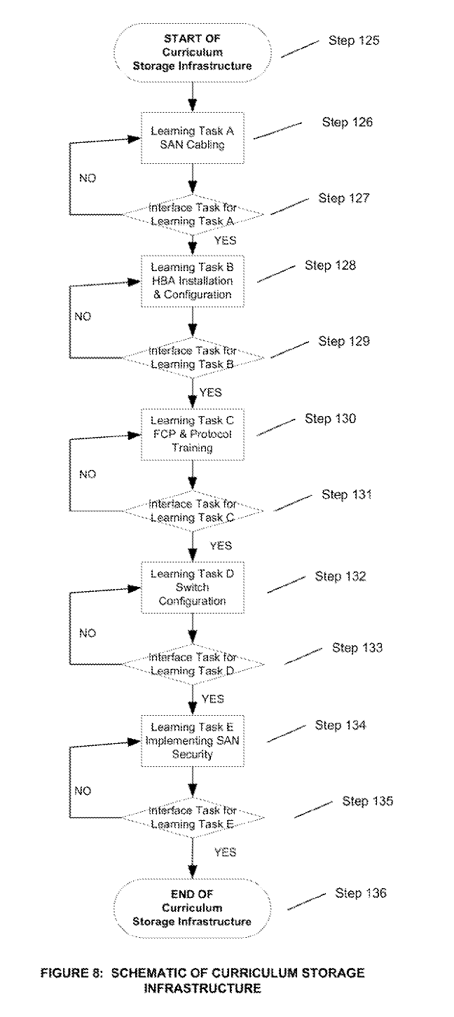

FIG. 8 shows a schematic of curriculum storage infrastructure. The example method of application is through the emphasis on different basic tasks, which forms the datacenter, IT solutions, operations and management.
Step 125 [user: trainee]: The start of curriculum Storage Infrastructure is performed.
Step 126 [user: trainee]: Learning Task A is performed.
Step 127 [user: trainee, supervisor]: Interface task for Learning Task A is performed. If the validation of Learning Task A is successful (‘yes’), the user continues to the next learning task. If the validation is not successful (‘no’), the user repeats the Learning Task A.
Step 128 [user: trainee]: Learning Task B is performed.
Step 129 [user: trainee, supervisor]: Interface task for Learning Task B is performed. If the validation of Learning Task B is successful (‘yes’), the user continues to the next learning task. If the validation is not successful (‘no’), the user repeats the Learning task B.
Step 130 [user: trainee]: Learning Task C is performed.
Step 131 [user: trainee, supervisor]: Interface task for Learning Task C is performed. If the validation of Learning Task C is successful (‘yes’), the user continues to the next learning task. If the validation is not successful (‘no’), the user repeats The Learning Task C.
Step 132 [user: trainee]: Learning Task D is performed.
Step 133 [user: trainee]: Interface task for Learning Task D is performed. If the validation of Learning Task D is successful (‘yes’), the user continues to the next learning task. If the validation is not successful (‘no’), the user repeats the Learning Task D.
Step 134 [user: trainee]: Learning Task E is performed.
Step 135 [user: trainee, supervisor]: Interface task for Learning Task E is performed. If the validation of Learning Task E is successful (‘yes’), the user continues to the next learning task. If the validation is not successful (‘no’), the user repeats the Learning Task E.
Step 136 [user: trainee]: The curriculum Storage Infrastructure ends.

### EXAMPLE 2 OF THE APPLICATION: LEARNING TASK

The Learning Task A “SAN cabling” from the above example 1 curriculum storage infrastructure is described by way of example in greater detail as follows:

Learning Task 1—SAN Cabling

Objectives
Identify the different types of fiber optical channel connectors.
Identify the different types of fiber optical cables.
Physically construct a simple SAN with fiber optical cables connecting switches, storage device and hosts.
Mount logical units/Drives in UNIX/windows systems.

Prerequisites
Basic understanding of SAN components.
Basic knowledge in Unix/Windows environment.

Equipments
Fiber channel connectors
SAN storage array
SAN switch
Unix server
Linux server
Windows server
Host bus adaptors

Introduction
Detailed description on optical fibers
Overview of how optical fibers transfer information
Describe the construction of optical fibers
Detailed description on the various types of connectors
Description of the SAN implementation

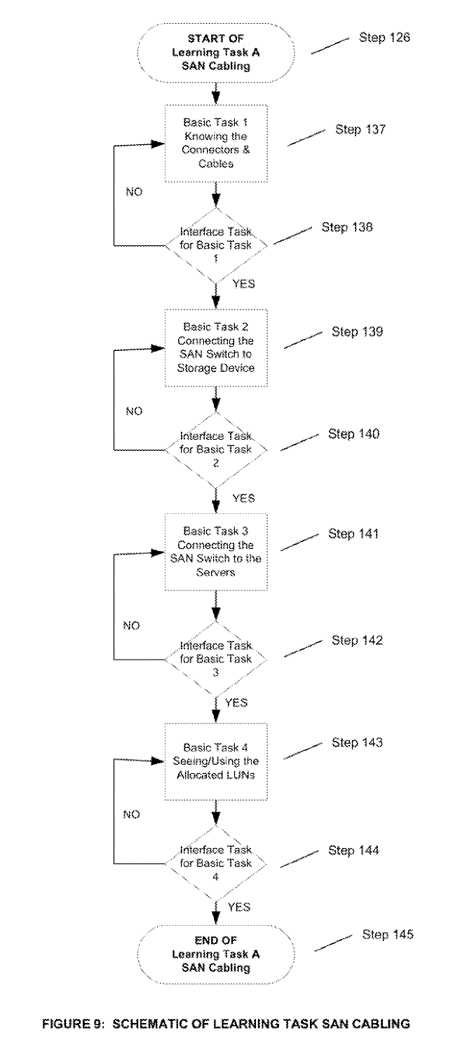

FIG. 9 shows Learning Task A “SAN cabling” comprises of the following basic tasks and interface tasks:

Step 126 [user: trainee] refers to the start of Learning Task A “SAN CABLING”.

Step 137 [user: trainee] refers to Basic Task 1—Knowing the connectors and cables.
Labeled samples on the different types of connectors and cables should be provided here. It would be good to layout the connectors and cables with proper labels in an acrylic box or on an acrylic panel.

Step 138 [user: trainees supervisor] refers to interface task of Basic Task 1—Knowing the connectors and cables
User asked to make observations on the different types of connectors and optical cables.

Step 139 [user: trainee] refers to Basic Task 2—Connecting the SAN switch to storage device
Connect SAN switch to storage device with an optical cable.
As a step-by-step guide to performing port configurations on the SAN switch and storage device.
Observe the change in the LEDs on the SAN switch and storage device.

Step 140 [user: trainee, supervisor] refers to interface task of Basic Task 2—Connecting the SAN switch to storage device.
Verify the connectivity with a management console (via SAN switch or storage device management software).

Step 141 [user: trainee] refers to Basic Task 3—Connecting the SAN switch to the servers:
Connect each of the servers to the SAN switch.
A step-by-step guide to initializing the HBAs and the ports on the SAN switch.
Observe the change in the LEDs on the SAN switch and HBAs.
Execute various commands on the servers to verify connectivity to the SAN switch.

Step 142 [user: trainee, supervisor] refers to Interface Task 3—Connecting the SAN switch to the servers:
Execute various command on the servers to verify connectivity to the SAN switch.

Step 143 [user: trainee] refers to Basic Task 4—Checking/using the allocated logical units
Logical units configuration and allocation to ports would have been performed.
Guide the candidates to seeing the logical units allocated to the HBAs on different servers.
Guide the students to formatting/creating a file system on the logical units for use.
Mount the logical units into the file system on the Unix machines.
Mount the logical units as drives for the Windows server.

Step 144 [user: trainee, supervisor] refers to interface task of Basic Task 4—checking/using the allocated logical units
Execute simple copy and listing commands to verify that the logical units can be used in both Windows and Unix environment

Step 145 [user: trainee] refers to the end of Learning Task A “SAN CABLING”.

Set of Instructions
Detailed information and specification on the IT technology vendors for SAN storage.
Detailed information and specification on the IT technology vendors for SAN switch.
Detailed information and specification on the IT technology vendors for servers.
Unix/Windows Commands.

The relevant Datacenter IT Solution Kit for the curriculum storage infrastructure is the demonstrative aspect for delivering the embodiment.

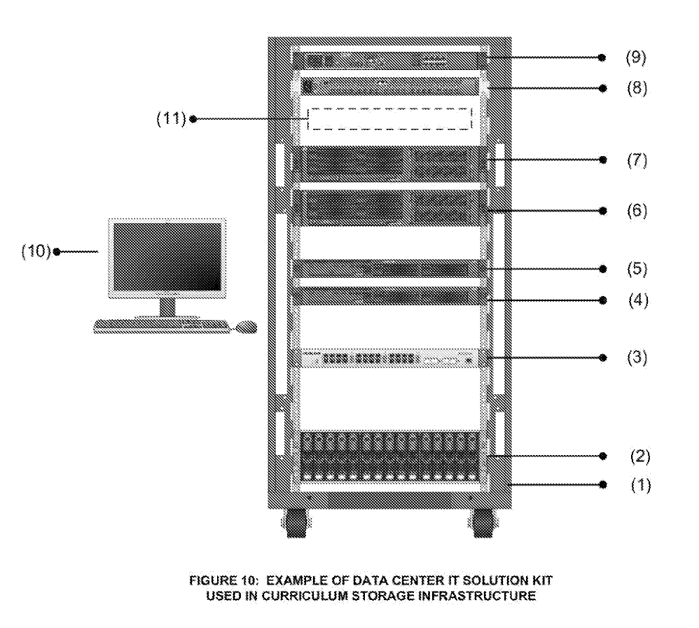

FIG. 10 shows a rack layout of an infrastructure solution kit for curriculum storage infrastructure.

The components provided inside a computer rack are as follows:
(1) All the above equipments are housed inside a customized rack with the front door showing the architecture diagram of this setup with wiring details. The rear door of the Datacenter IT Solution Kit will have sockets (patch panel) to plug and connect this different equipment for users to wire and connect the different components/equipments of this Datacenter IT Solution Kit.
(2) Storage array with FC connectivity
(3) SAN switch
(4) Window server
(5) Linux server
(6) Unix server from technology vendor 1
(7) Unix server from technology vendor 2
(8) Ethernet switch
(9) Console switch
(10) Monitor with keyboard/mouse which can be provided in or on the rack
(11) Patch panel for interconnecting the various IT equipments by the user to meet the curriculum requirements. The patch panel is placed at the rear end of the rack.

### EXAMPLE 3 OF THE APPLICATION: Troubleshooting—SOLVING A PROBLEM (1)

The application describes in greater detail by way of example which covers:
1. Presenting a problem scenario in the shared storage solution designed in example 1.
2. Applying the embodiment to the datacenter IT Solution, operation and management by way of identifying the learning task, method of learning, teaching and training of the learning task, and the Datacenter IT Solution Kit to provide the practical components of the learning task.

Problem Scenario:
The user is unable to access data. He tries to access data on the shared storage 2, using the Linux server 5 but this fails. What the requirements mean is that the IT services cannot access data from an external centralized storage.

In the present example, the reason for this malfunction can virtually be found in any of the equipments of the Datacenter IT Solution Kit.

What the user does not know is that the problem is caused by a faulty SAN cabling, which connects the shared storage 2 through the SAN switch 3 with the Linux server 5.

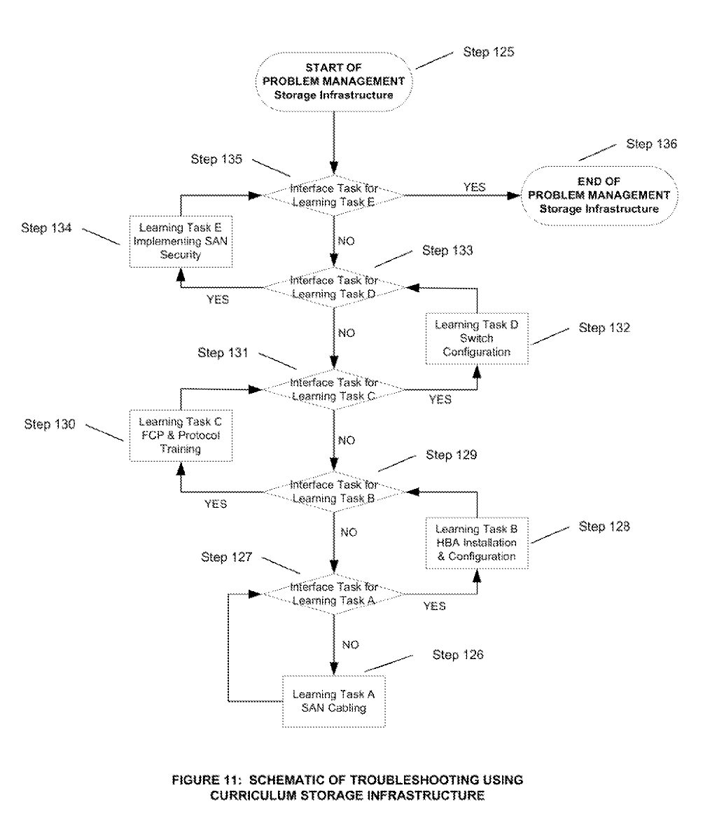

The problem is translated to the curriculum storage infrastructure of the application. Problem identification and resolution starts from interface task of Learning Task E to Interface task of Learning Task A—as follows (see FIG. 11), by following the steps of FIG. 8 in reverse order until the problem is narrowed down to a specific interface task.
Step 125 [user: trainee]: Start of problem management of Storage Infrastructure.
Step 135 [user: trainee]: Interface task of Learning Task E—user checks the status of SAN Security is performed. If this fails, then continue to Step 133, or else go to Step 136 to end of problem management of Storage Infrastructure.
Step 133 [user: trainee]: Interface task of Learning Task D—user checks the status of switch configuration is performed. If this fails, then continue to Step 131, or else perform Step 134.
Step 131 [user: trainee]: Interface task of Learning Task C—user checks the status of FCP and protocol tracing is performed. If this fails, then continue to Step 129, or else perform Step 132.
Step 129 [user: trainee]: Interface task of Learning Task B—user checks the status of HBA Installation and configuration is performed. If this fails, then continue to Step 127 or else perform Step 130.
Step 127 [user: trainee]: Interface task of Learning Task A—user checks the status of SAN cabling is performed. If this fails, then perform Step 126, or else perform Step 128.
Step 136 [user: trainee]: Problem management of Storage Infrastructure ends.

In this example, all of the above interface tasks fails and we need to execute Learning Task A (i.e. step 126).

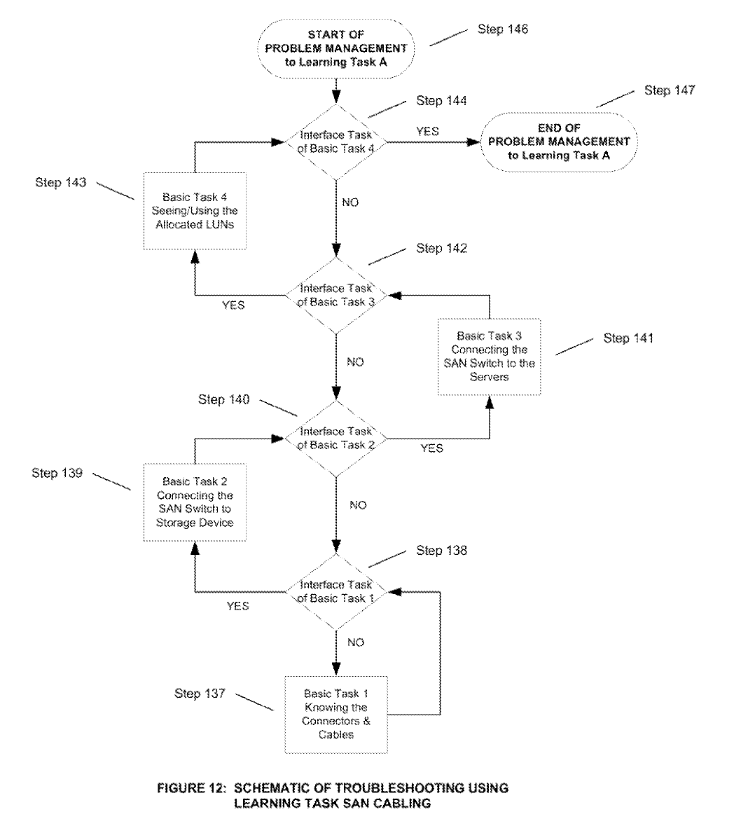

FIG. 12 is a schematic of troubleshooting using learning task SAN cabling.
Step 146 [user: trainee]: the start of problem management to Learning Task A is performed.
Step 144 [user: trainee]: Interface task for Basic Task 4 is performed where user executes simple “copy” and “listing” commands to verify that the logical units can be used in Linux environment. If Interface task fails (‘NO’), then go to step 142.
Step 142 [user: trainee]: Interface task for Basic Task 3 is performed where user executes various command on the servers to verify connectivity to the SAN switch. If interface task fails (‘NO’), then go to step 140.
Step 140 [user: trainee]: Interface task for Basic Task 2 is performed where user verifies the connectivity with a management console (via SAN switch or storage device management software). Interface task fails (‘NO’), then go to Step 138.
Step 138 [user: trainee]: Interface task for Basic Task 1 is performed where user makes observations on the different types of connectors and optical cables. The LEDs are not green. If interface task fails (‘NO’), then go to step 137.
Step 137 [user: trainee]: Basic Task 1 is performed as shown in example 2.
Step 138 [user: trainee, supervisor]: Interface task for Basic Task 1 is performed as shown in example 2. If interface task correct (‘YES’), then go to Step 139.
Step 139 [user: trainee]: Basic Task 2 is performed as shown in example 2.
Step 140 [user: trainee, supervisor]: Interface task for Basic Task 2 is performed as shown in example 2. If interface task is correct (‘YES’), then go to Step 141.
Step 141 [user: trainee]: Basic Task 3 is performed as shown in example 2.
Step 142 [user: trainee, supervisor]: Interface task for Basic Task 3 is performed as shown in example 2. If interface task is correct (‘YES’), then go to Step 143.
Step 143 [user: trainee]: Basic Task 4 is performed as shown in example 2.
Step 144 [user: trainee, supervisor]: Interface task for Basic Task 4 is performed as shown in example 2. If interface task is correct (‘YES’), then go to Step 147.
Step 147 [user: trainee]: The problem management of Learning Task A ends.

### EXAMPLE 4 OF THE APPLICATION: SOLVING A PROBLEM (2)

The application describes in greater detail by way of example:
1. Presenting a problem scenario in the shared storage solution designed under the Datacenter IT Solution Kit.
2. Applying the embodiment to the datacenter IT solution, operation and management by way of identifying the learning task, method of learning, teaching and training of the learning task, and the Datacenter IT Solution Kit to provide the practical component of the learning task.

Problem Scenario:
The user is unable to access data. The user tries to access data on the shared storage 2, using the Linux server 5 but this fails. What the requirements mean is that the IT services cannot access data from an external centralized storage.
What the user does not know is that the problem is caused by a logical connectivity of the shared storage 2 with the Linux server 5.

The problem is translated to the curriculum storage infrastructure of the application—Learning Task 1.

Refer to FIG. 12.
Step 146 [user: trainee]: The start of problem management to Learning Task A is performed.
Step 144 [user: trainee]: Interface task for Basic Task 4 is performed where user executes simple “copy” and “listing” commands to verify that the logical units can be used in Linux environment. If interface task fails (‘NO’), then go to step 142.
Step 142 [user: trainee]: Interface task for Basic Task 3 is performed where user executes various command on the servers to verify connectivity to the SAN switch. Interface task is correct (‘YES’), go to step 143.
Step 143 [user: trainee]: Basic Task 4 is performed as shown in example 2.
Step 144 [user: trainee, supervisor]: Interface task for Basic Task 4 is performed as shown in example 2. If interface task is correct (‘YES’), then go to step 147.
Step 147 [user: trainee]: The problem management of Learning Task A ends.

An example of intended use of this application is hands-on learning aid to be used in any learning institutions or organization employing datacenter IT practitioners.

Although examples of the application are described herein in detail, it is desired to emphasize that this has been for the purpose of illustrating the application and should not be considered as the only available functions of the application. Many modifications and variations can be made by those skilled in the art while still practising the application.

As for example, the application (both the method of design, implementing and troubleshooting and method of learning, teaching and training datacenter IT solutions, operations and management, with the Datacenter IT Solution Kit) can be extended to any datacenter IT solutions, below are just some examples:
Storage infrastructure
Storage management Service
Server virtualization
High availability applications
Performance analysis

The application provides a structured method for design, implementing and troubleshooting datacenter IT solutions, methods are organized into 3 types of tasks—basic, learning, interface—such that the interface tasks serve as steps of the method to systematically troubleshoot the IT related solution in the event of a technical problem.

A method is provided for learning, teaching, training datacenter IT solution, operations and management in structured method, sequencing of tasks into different learning tasks, basic tasks and interface tasks to form the datacenter IT solution to meet the technical or business requirements.

The application provides a datacenter IT solution in a Kit, which is the real world IT equipments housed in a portable equipment rack. This helps as teaching aid for both students and practitioners in learning the Data IT solution formation to meet the business or technical requirements, operations and management of the solution

A method of training of at least one individual or a group of individuals is provided, comprising the steps of:
a) Providing a problem i.e. problem based learning
b) Causing the at least one individual to solve the problem

A method of teaching information to an individual or to a group of individuals by providing the information and transmitting the information is provided, comprising the following steps:
a) Orally
b) With data played to them over Internet or from data carrier

### SUMMARY

The application provides a method to design, implement, and troubleshoot datacenter IT solutions in a structured way where the steps of the method are organized into 3 types of tasks—basic, learning, interface tasks, such that the interface tasks serve as steps of the method to either systematically verify the basic/learning tasks performed successfully, or to troubleshoot the IT related solution in the event of a technical problem.

The application provides a method of teaching, learning and training datacenter IT solutions in a defined structured approach and accompanied with real-world datacenter IT equipments housed in a portable Datacenter IT Solution Kit. The application provides real-world experience in learning datacenter IT solutions, operations and management. The Datacenter IT Solution Kit is used to provide validation and error messages that are a cart of the method of learning, teaching, training datacenter IT solutions, operations and management.

The application extends to troubleshooting by way of interface tasks. The reverse sequence in executing defined interface tasks provides a problem identification method. Executing the related basic tasks solves the identified problem.

The application comprises, among other things:
1. A curriculum which is an IT solution related to datacenter IT solution, operations and management. The embodiment is demonstrated via the Datacenter IT Solution Kit.
2. A curriculum is built from a set of predefined learning tasks.
3. Learning tasks are datacenter IT scenarios found in datacenter IT solutions, operations and management.
4. A learning task is built from a set of predefined basic tasks.
5. Basic tasks are datacenter IT activities, which are demonstrated via the Datacenter IT Solution Kit.
6. Basic tasks are executed as a set of defined instructions for a plurality of IT equipments.
7. Interface tasks are datacenter IT validation activities, which are demonstrated via the Datacenter IT Solution Kit.
8. Interface tasks are executed as a set of defined instructions for a plurality of IT equipments.
9. The set of defined instructions related to the application can be adapted to future developed technologies will evolve to meet with technologies while the method and process of application remain relevant at all times.

An example of the intended usefulness of this application is a practical hands-on learning aid to be used in any learning institutions or organizations employing Data Center IT practitioners.

### BACKGROUND

The application covers the designing, implementing and troubleshooting datacenters IT solutions and method for learning, teaching and training datacenter IT solutions, operations and management using Datacenter IT Solution Kit.

Technology vendors design and manufacture the IT equipments. In the technology vendor arena, these IT equipments are also called IT products. Many technology vendors provide hands-on training programs limited to their own IT equipments and related technologies. Vendor-focused curriculums are point IT solutions and do not give an understanding of complete end-to-end datacenter IT solutions, operations and management.

The embodiments address the complexity of IT datacenter solutions, operations and management faced by IT practitioners. Building a datacenter requires IT practitioners to understand the different IT equipments (both hardware and software) and the underlying technologies and technology standards of the IT equipments. Putting together different IT equipments will form the datacenter IT solution to meet certain business requirements or technical requirements.

The plurality of IT equipments in a datacenter often creates blame-storms by technology vendors at the expense of the customer's business and technical requirements. The existing usual approach of IT solution for a heterogeneous datacenter does not provide a systematic Troubleshooting approach for IT practitioners. However, this present application provides a structured method for the design, implementation and troubleshooting IT solutions related to real-life datacenter.

In addition, the present application offers solutions to the limitations in the learning, teaching and training curriculum of datacenters IT solutions in higher learning and learning institutions such as the polytechnics and the universities. Despite that these institutes of learning are continuously evolving the content of their teaching curriculum trying to meet industry needs, there is still a gap for them to cover practical datacenter IT solutions, operations and management in the real-world.

The curriculum of the embodiment adds a third group-datacenter IT Solution operations and management to the existing two broad groups of IT curriculum at learning institutions:
Computer Programming Assessments focused on application coding
Hardware Design and Assessments focused on hardware logic

1.-16. (canceled)

17. Method of providing a set of pre-defined datacenter IT solution tasks which are to be performed by at least one user for setting up a datacenter for providing a pre-defined IT solution, the method comprising the step of providing the datacenter IT solution tasks in groups of basic tasks and groups of learning tasks, such that each learning task comprises one or more basic task, the method further comprising the step of providing a sequence of interface tasks, wherein at least one interface task being assigned to at least one basic task or to at least one learning task, an interface task providing a predefined instruction or set of instructions for validation of the correctness of the performed learning task or interface task, the reverse sequence of the interface tasks providing a set of instructions for identifying the cause of a problem in the datacenter IT solution.

18. Method of providing a set of pre-defined datacenter set-up tasks according to claim 17, wherein a corresponding interface task is provided for each basic task.

19. Method of providing a set of pre-defined datacenter set-up tasks according to claim 17, wherein a corresponding interface task is provided for each leaning task.

20. Method of providing information, the method comprising the following steps:
providing groups of learning tasks, groups of basic tasks and a sequence of interface tasks according to one of the aforementioned claims, providing the basic tasks and learning tasks in the sequence of the respective interface tasks.

21. Method of teaching information to an individual or to a group of individuals, the method comprising the following steps:
providing information according to claim 20,
transmitting the information to the individual or to the group of individuals.

22. Method of teaching information according to claim 21, wherein the information is provided orally by an individual.

23. Method of teaching information according to claim 21, wherein the information is provided in a written form on paper.

24. Method of teaching information according to claim 21, wherein the information is provided with data which is downloaded from a network such as the Internet or from a data carrier.

25. Method of training of at least one individual or a group of individuals, the method comprising the following steps:
teaching according to claim 21 until a pre-determined current learning task or basic task is reached,
causing the individual to repeat the basic tasks learning tasks that have been taught so far,
performing the current interface task which is assigned to the current basic task or learning task, that has been taught,
verifying whether the datacenter IT solution comprises the characteristic behaviour of the current interface task.

26. Method according to claim 25, wherein—if the verification step was successful—the steps of claim 25 are performed until reaching the next pre-determined learning task or basic task, performing the interface task which is assigned to the next basic task or learning task, that has been taught, and verifying whether the datacenter IT solution comprises the characteristic behavior of that next interface task.

27. Method according to claim 25, wherein—if the verification step was not successful—the steps of claim 25 are performed until reaching a previous pre-determined learning task or basic task, performing the previous interface task which is assigned to the previous basic task or learning task, and verifying whether the datacenter IT solution comprises the characteristic behavior of the previous interface task.

28. Method according to claim 25, wherein—if the verification step was not successful—the steps of claim 25 are repeated again until reaching the current learning task or basic task, performing again the current interface task, and verifying again whether the datacenter IT solution comprises the characteristic behavior of the current interface task.

29. Method of training of at least one individual or a group of individuals
providing a problem in a datacenter IT solution,
providing groups of learning tasks, groups of basic tasks and a sequence of interface tasks according to claim 17,
causing the at least one individual to solve the problem by performing the reverse sequence of the interface tasks, for each interface task verifying whether the datacenter IT solution comprises the characteristic behavior of that interface task,
wherein—if a verification step is not successful for a current interface task—the basic and learning tasks which are assigned to the current interface task are performed.

30. Method of training of at least one individual or a group of individuals according to claim 29, the method comprising the steps of performing the reverse sequence of the interface tasks before the current interface task, for each interface task verifying whether the datacenter IT solution comprises the characteristic behavior of that interface task, wherein—if a verification step is not successful for an interface task before the current interface task—the basic and learning tasks which are assigned to the interface task before the current interface task are performed.

31. Printed Matter with the information provided by the method of claim 20.

32. Data carrier with the information provided by the method of claim 20.

33. Computer program, performing the method of claim 17.

34. Computer program, performing the method of claim 20.

35. Computer program, performing the method of claim 21.

36. Computer program, performing the method of claim 25.

37. Computer program, performing the method of claim 29.

38. A Datacenter IT Solution Kit which comprises a single portable rack housing IT equipments, namely
at least one external storage device,
at least one SAN switch device,
at least one server computer,
at least one Ethernet network device such as a LAN switch,
at least one console device,
a data input device and a display,
a patch panel for interconnecting the IT equipments,
at least one application software which is running on the server,
at least one system management software which is running on the server,
a connection for supplying electrical power to the components in the rack,
a connection with a super-ordinate data network.
